(19) United States
(12) Patent Application Publication
(10) Pub. No.: US 2002/0154336 A1
(43) Pub. Date: Oct. 24, 2002

(54) Image processing apparatus, method of controlling an image processing apparatus, and storage medium

(76) Inventor: Hirofumi Takei, Tokyo (JP)

Correspondence Address: FITZPATRICK CELLA HARPER & SCINTO, 30 ROCKEFELLER PLAZA, NEW YORK, NY, 10112, US

(21) Appl. No.: 10/121,652

(22) Filed: Apr. 15, 2002

(30) Foreign Application Priority Data
Apr. 19, 2001 (JP) 2001/120446

(51) Int. Cl. B41F 1/00; G06F 15/00

(52) U.S. Cl. 358/1.15

(57) ABSTRACT

Image data being displayed and a print information file associated with the image data are stored into a storage medium in a highly efficient manner. If a storage switch is turned on to issue a command to store image data being displayed on a monitor, a controller produces a print information file on the basis of a pre-stored print condition in response to the command. The produced print information file is stored together with the image data into a memory card.

### BACKGROUND OF THE INVENTION

1. Field of the Invention

The present invention relates to an image be processing apparatus for managing image data stored in a storage medium in accordance with a predetermined format. The present invention also relates to a method of controlling such an image processing apparatus, and to a storage medium.

2. Description of the Related Art

It is known in the art to describe, in accordance with a particular file format, a manner of printing image data stored in a storage medium attachable/removable to/from an image processing apparatus such as a digital camera. An example of such a file format is the DPOF (Digital Print Order Format) standard.

Automatic printing information is described in a DPOF file according to the DPOF standard, and the DPOF file is stored, together with digital image files taken using a digital camera or the like, into a removal storage medium such as a CF (Compact Flash) card or an MMC (Multi Media Card). When the digital image data is printed, printing can be automatically performed in accordance with specifications described in the DPOF file.

In a DPOF file, information that specifies a manner of printing a particular digital image stored in a removal storage medium is described.

Recently, many electronic devices are capable of dealing with a small-sized removal storage medium, and many digital cameras are capable of storing a DPOF file into a removable medium. For example, in some recently developed camcorders, moving images are recorded on a dedicated recording medium such as a videotape, and still images are stored in a removable medium such as an MMC card together with a DPOF file.

In such conventional camcorders having the capability of storing a DPOF file, a complicated process is needed, as will be described below, to select the desired images to be printed from a sequence of live images being taken or from a sequence of playback images and to describe DPOF information associated with the selected images.

In the case in which a still image file is produced when an image is being taken, a still image capture switch, which is also called a photo switch, is pressed to store a still image file into a removable medium. Similarly, in the case in which a still image file is produced from a playback image recorded on a videotape, the still image capture switch is pressed when a desired image is displayed thereby storing the displayed image in the form of a still image file into a removable medium.

Thereafter, to check the captured still image, the system is brought into a still image display mode and the still image stored in the removal storage medium is displayed on a TV monitor or the like. If a user decides to print the still image being displayed, the user describes, in a DPOF file, print information (representing a print size, color correction information, etc.) associated with the still image by operating a switch. The user has to perform the complicated process described above for each still image to be printed.

In particular, when there are a large number of still images to be printed, or when print information includes a large number of items, the process of describing the DPOF file becomes very complicated and time-consuming.

### SUMMARY OF THE INVENTION

It is an object of the present invention to solve all or at least one of the problems described above.

More specifically, it is an object of the present invention to provide an image processing apparatus capable of freely configuring an image processing environment that allows image data being displayed and a print information file associated with the image data to be stored in a highly efficient manner by a simple operation. It is another object of the present invention to provide a method of controlling such an image processing apparatus. It is still another object of the present invention to provide a storage medium storing a computer program according to such a method.

According to an aspect of the present invention, there is provided an image processing apparatus capable of storing input image data into a storage medium together with a print information file describing print information associated with the image data, the image processing apparatus comprising: a print condition setting unit for setting a print condition; a storage unit for storing the print condition set by the print condition setting unit; a display unit for displaying input image data; a storage command issuing unit for issuing a command to store the image data displayed on the display unit into the storage medium; a producing unit for, in response to the image data storage command issued by the storage command issuing unit, producing a print information file in accordance with the print condition stored in the storage unit; and a control unit for, in accordance with the image data storage command issued by the storage command issuing unit, controlling an operation such that the print information file produced by the producing unit and the image data displayed on the display unit are stored into the storage medium.

According to another aspect of the present invention, there is provided a method of controlling an image processing apparatus capable of storing input image data into a storage medium together with a print information file describing print information associated with the image data, the method comprising the steps of: setting a print condition; storing the print condition set by the print condition setting step into a storage unit; issuing a command to store input image data into the storage medium, if the image data storage command is issued in the storage command issuing step, setting the print condition stored in the storage unit to the image data, and in response to the image data storage command issued in the storage command issuing step, controlling an operation such that the image data whose print condition has been set in the setting unit is stored into the storage medium.

Further objects, features and advantages of the present invention will become apparent from the following description of the preferred embodiments with reference to the attached drawings.

### BRIEF DESCRIPTION OF THE DRAWINGS

FIG. 1 is a block diagram illustrating a construction of an image processing apparatus according to a first embodiment of the present invention;

FIG. 2 is a flow chart showing an example of a first data processing procedure performed in the image processing apparatus according to the first embodiment;

FIG. 3 is a flow chart showing an example of a second data processing procedure performed in the image processing apparatus according to the first embodiment;

FIG. 4 is a diagram showing an example of print information stored in a memory card shown in FIG. 1;

FIG. 5 is a flow chart showing an example of a third data processing procedure performed in the image processing apparatus according to the first embodiment;

FIG. 6 is a block diagram illustrating a construction of an image processing apparatus according to a second embodiment of the present invention;

FIG. 7 is a flow chart showing an example of a fourth data processing procedure performed in the image processing apparatus according to the second embodiment;

FIG. 8 is a flow chart showing an example of a fifth data processing procedure performed in the image processing apparatus according to the second embodiment; and

FIG. 9 is a diagram showing a memory map of a storage medium storing various data processing programs that are readable by an image processing system including an image processing apparatus according to an embodiment of the present invention.

### DESCRIPTION OF THE PREFERRED EMBODIMENTS

First Embodiment

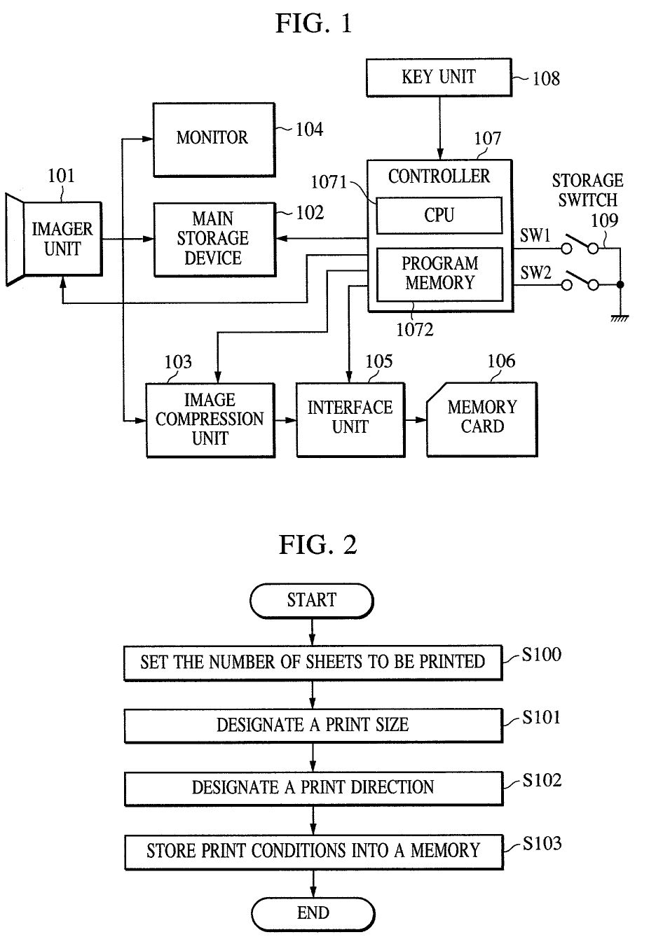

FIG. 1 is a block diagram illustrating a construction of an image processing apparatus according to a first embodiment of the present invention.

In FIG. 1, an imager unit 101 takes an image of a subject and outputs a video signal thereof. The video signal outputted from the imager unit 101 is inputted to a main storage unit 102. The main storage unit 102 may include a magnetic tape, a magnetic disk, or a high-capacity semiconductor memory.

An image compression unit 103 processes a video signal supplied from the imager unit 101 or a playback signal read from the main storage unit 102 in accordance with a control signal supplied from a controller 107 such that the video signal or the playback signal is captured and converted into still image data in a compressed form.

The video signal from the imager unit 101 or the playback signal read from the main storage unit 102 is supplied to a monitor such as a liquid crystal display (LCD) 104. The monitor 104 displays an image in accordance with the supplied video signal or the playback signal. Reference numeral 105 denotes an interface unit via which compressed image data outputted from the image compression unit 103 and DPOF data outputted from the controller 107 are written into a memory card 106.

A removable memory card such as a CF (Compact Flash) card or an MMC (Multi Media Card) may be employed as the memory card 106 used to store various data.

The controller 107 includes a CPU 1071 and a program memory 1072. The CPU 1071 controls various constituent parts of the image processing apparatus in accordance with a control procedure that will be described later with reference to a flow chart. The program memory 1072 stores a program describing the control procedure according to which the CPU 1071 operates.

A key unit 108 for controlling the operation of the camcorder and a storage switch 109 used to perform a recording operation are connected to the controller 107. The storage switch 109 operates as a two-stage switch. When the storage switch 109 is pressed to a half-stroke position, a switch SW1 is turned. If the storage switch 109 is further pressed to a full-stroke position, a switch SW2 is also turned on in addition to the switch SW1.

FIG. 2 is a flow chart showing an example of a first data processing procedure performed in the image processing apparatus according to the present embodiment. This first data processing procedure includes steps S100 to S103 through which a print condition is set in the camcorder shown in FIG. 1. Program code representing the procedure including these steps is stored in the program memory 1072 shown in FIG. 1, and the steps S100 to S103 are performed by the CPU 1071 in accordance with the program code stored in the program memory 1072.

First, in step S100, setting is performed in terms of how many copies are to be printed for an image. Thereafter, in step S101, the print size of the image is set. In step S102, an image rotation direction (indicating whether the image is to be printed in a horizontal or vertical direction) is set. In step S103, the print condition that has been set in the previous steps is stored in a print condition memory provided in the controller 107. Thus, the procedure is completed.

In the above procedure, the print condition may be stored in a memory card 106. In this case, in order to distinguish a file of the print condition from a DPOF file that will be stored later, it is desirable that the file of the print condition has an identifier different from that of the DPOF file.

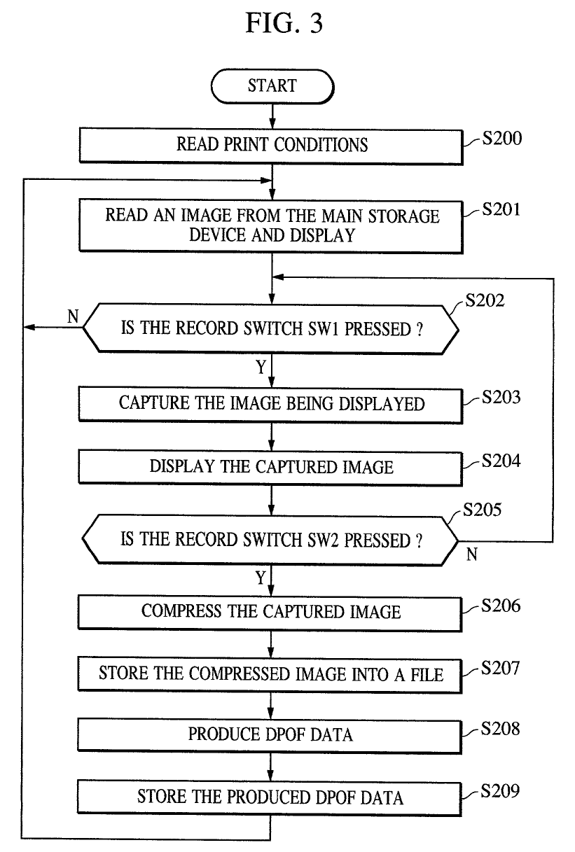

FIG. 3 is a flow chart showing an example of a second data processing procedure performed in the image processing apparatus according to the present embodiment. This second data processing procedure includes steps S200 to S209 and is concerned with a playback-mode operation of the camcorder shown in FIG. 1. Program code representing the procedure including these steps is stored in the program memory 1072 shown in FIG. 1, and the steps S200 to S209 are performed by the CPU 1071 in accordance with the program code stored in the program memory 1072.

First, in step S200, the print condition, which was set in the print condition setting procedure shown in FIG. 2, is read from the print condition memory provided in the controller 107. Thereafter, in step S201, a playback image is displayed on the monitor 104 in accordance with image data stored in the main storage unit 102.

In step S202, it is determined whether the switch SW1 of storage switch 109 is turned on by pressing the storage switch 109. If the switch SW1 is not turned on, the procedure returns to step S201 to continue displaying the playback image.

On the other hand, if it is determined in step S202 that the switch SW1 is turned on by pressing the storage switch 109, the process proceeds to step S203, in which a playback image that is displayed in accordance with image data read from the main storage unit 102 is held and captured into the image compression unit 103.

In step S204, the monitor 104 displays the image captured into the image compression unit 103. If a user of the camcorder decides to store the captured image as a still image, the user presses the storage switch 109 to the full-stroke position, thereby turning on the second-stage switch SW2.

In step S205, it is determined whether the switch SW2 is turned on by pressing the storage switch 109. If the switch SW2 is not turned on, the procedure returns to step S202.

On the other hand, if it is determined in step S205 that the switch SW2 is turned on by pressing the storage switch 109, the procedure proceeds to step S206, in which the image compression unit 103 compresses the captured image data.

In step S207, the compressed image file is stored into the memory card 106 via the interface unit 105. Thereafter, in step S208, DPOF data is produced that will be described later. In step S209, the DPOF data produced in the previous step is stored in the form of a file into the memory card 106 via the interface unit 105. After completion of storing the DPOF file into the memory card 106, the procedure returns to step S201 to restart the playing back of image data stored in the main storage unit 102.

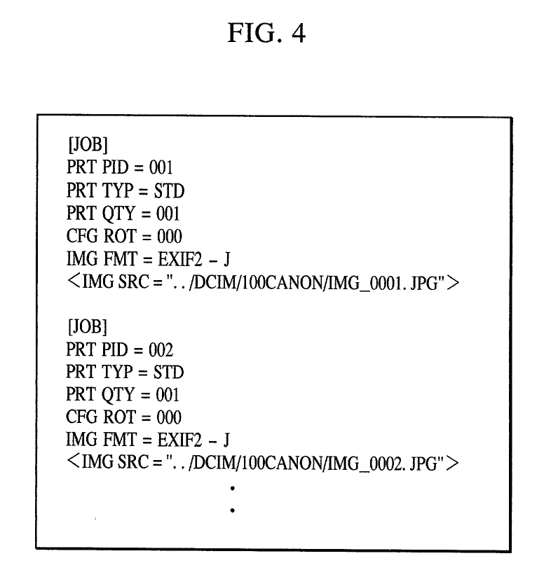

FIG. 4 shows an example of print information stored in the memory card 106.

In FIG. 4, “JOB” denotes a section in which print information is stored, and “PRT PID” denotes an ID (identification) identifying a particular print condition associated with a particular image.

“PRT TYP” denotes a parameter indicating a print type. In the example shown in FIG. 4, “STD” denotes that a standard print type is specified.

“PRT QTY” is a parameter indicating the number of copies to be printed. In the example shown in FIG. 4, “one” copy is specified. “CFG ROT” is a parameter indicating an image rotation direction. In the example shown in FIG. 4, “CFG ROT” is set to “000”, specifying that the image should be printed in a landscape fashion, which is most commonly employed.

“IMG FMT” denotes a format of the image file to be printed. In the example shown in FIG. 4, the “IMG FMT” is set to “EXIF2-J”. “IMG SRC” indicates the path of an image file stored in the memory card 106. In the example shown in FIG. 4, image files are specified by “IMG_{—}0001.JPG” and “IMG_{—}0002.JPG”.

If the storage switch 109 is pressed when a desired image is displayed on the monitor 104 as described above, a still image file such as IMG_{—}0001.JPG or IMG_{—}0002.JPG in a compressed form is produced. In addition, a DPOF file such as that shown in FIG. 4 is also produced.

In the example described above, the storage switch 109 is pressed twice to store two images. If the storage switch 109 is further pressed, a section similar to that denoted by “JOB” is added to the DPOF file each time the storage switch 109 is pressed.

By storing a DPOF file together with image files in a storage medium, it becomes possible to automatically print images in the manner specified in the DPOF file using a printer at a user's place or at a print shop.

By constructing and operating the image processing apparatus in the above-described manner, it becomes possible to easily produce, in addition to a desired still image file, a DPOF file in which a print condition associated with the still image is described simply by pressing the storage switch when the desired image is being displayed on the camcorder.

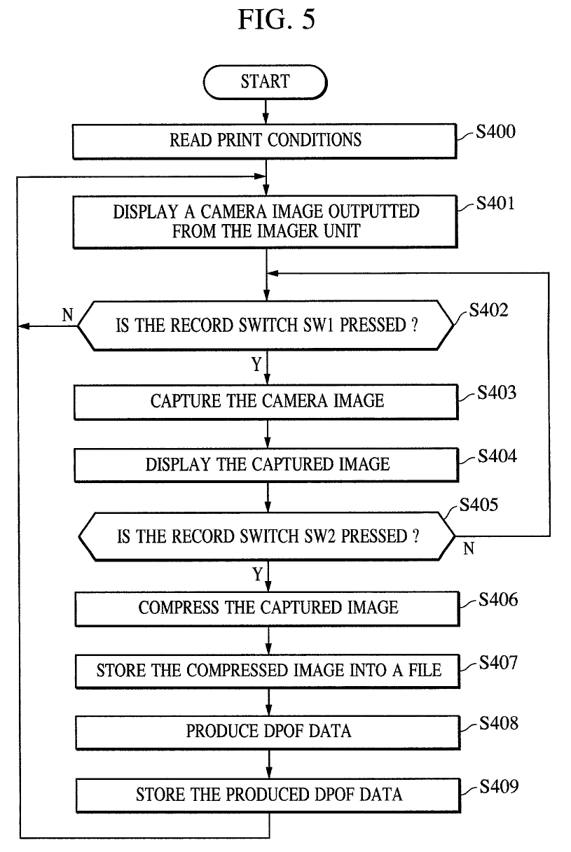

FIG. 5 is a flow chart showing an example of a third data processing procedure performed in the image processing apparatus according to the first embodiment. This third data processing procedure includes steps S400 to S409 and is concerned with an operation of creating a still image file and a DPOF file when an image is being taken using a camcorder or a digital still camera.

First, in step S400, a preset print condition is read from the internal memory of the controller 107. In step S401, a live image being taken by the imager unit 101 is displayed on the monitor 104.

In step S402, it is determined whether the switch SW1 of storage switch 109 is turned on by pressing the storage switch 109. If it is determined that the switch SW1 10 is not turned on by pressing the storage switch 109, the procedure returns to step S401 to continue displaying the live image being taken.

On the other hand, if it is determined in step S402 that the switch SW1 is turned on by pressing the storage switch 109, the process proceeds to step S403, in which the image being taken by the imager unit 101 is captured into the image compression unit 103. In step S404, the monitor 104 displays the image captured in the image compression unit 103. If a user of the camcorder decides to store the captured image as a still image, the user presses the storage switch 109 to the full-stroke position thereby turning on the second-stage switch SW2.

In step S405, it is determined whether the switch SW2 is turned on by pressing the storage switch 109. If it is determined that the switch SW2 is not turned on by pressing the storage switch 109, the procedure returns to step S402.

On the other hand, if it is determined in step S405 that the switch SW2 is turned on by pressing the storage switch 109, the procedure proceeds to step S406, in which the image compression unit 103 compresses the captured image.

In step S407, the compressed image file is stored into the memory card 106 via the interface unit 105. Thereafter, in step S408, DPOF data is produced as described above. In step S409, the DPOF data produced in the previous step is stored in the form of a file into the memory card 106 via the interface unit 105. After completion of storing the DPOF file, the procedure returns to step S401 to continue displaying the live image being taken by the imager unit 101.

When a large number of images are stored, if the above-described operation is performed repeatedly, print conditions associated with the respective images are automatically described without having to individually set the print conditions. This is very convenient for the user.

In the above-described operation, when a second or following image is stored, print information associated with the second or following image is added to the DPOF file that has already been created.

That is, the print conditions associated with the second and following images are described in the same DPOF file in which the print condition associated with the first image is described.

As described above, when the user wants to store an image being taken by the camcorder or the like, the user can easily produce, in addition to a still image file, a DPOF file in which a print condition associated with the still image is described, simply by pressing the storage switch when the desired image is being displayed on the camcorder or the like.

Second Embodiment

A second embodiment is described below which is similar to the first embodiment except that a DPOF switch 110 used by a user to issue a command to produce a DPOF file is added to the controller 107.

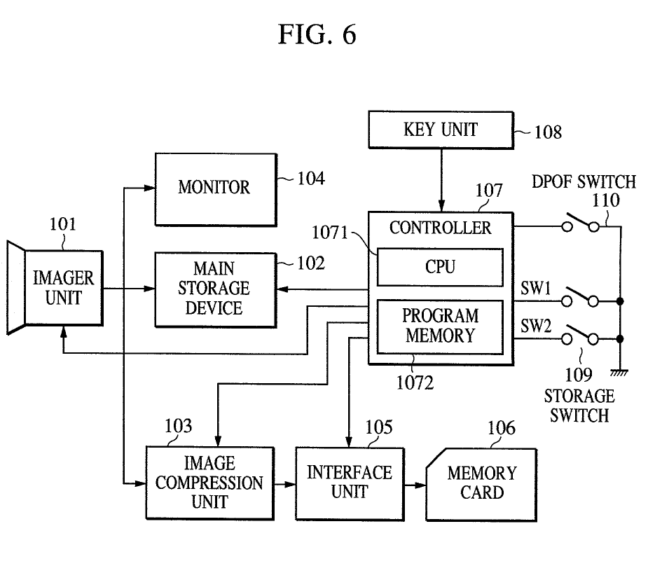

FIG. 6 is a block diagram illustrating a construction of an image processing apparatus according to a second embodiment of the present invention, wherein similar parts to those in FIG. 1 are denoted by similar reference numerals.

In FIG. 6, reference numeral 110 denotes a DPOF switch. The CPU 1071 determines whether the DPOF switch 110 is pressed and controls the operation of producing a DPOF file depending on whether the DPOF switch 110 is pressed. More specifically, if it is determined that the DPOF switch 110 is not pressed (not turned on), only a compressed image file is produced without producing a DPOF file.

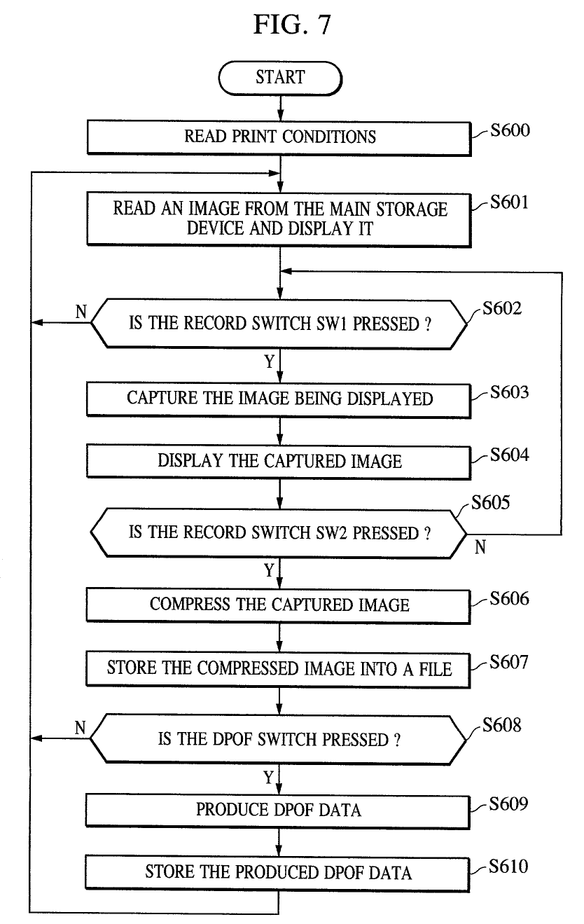

FIG. 7 is a flow chart showing an example of a fourth data processing procedure performed in the image processing apparatus according to the second embodiment. This fourth data processing procedure includes steps S600 to S610 and is concerned with an operation of the camcorder in a playback mode, wherein the procedure is performed by the CPU 1071 in accordance with the program code stored in the program memory 1072.

First, in step S600, a preset print condition is read from the internal memory of the controller 107. Thereafter, in step S601, a playback image is displayed on the monitor 104 in accordance with image data stored in the main storage unit 102.

In step S602, it is determined whether the switch SW1 is turned on by pressing the storage switch 109. If it is determined that the switch SW1 is not turned on, the procedure returns to step S601 to continue displaying the playback image.

On the other hand, if it is determined in step S602 that the switch SW1 is turned on by pressing the storage switch 109, the procedure proceeds to step S603, in which a playback image that is displayed in accordance with image data read from the main storage unit 102 is held and captured into the image compression unit 103.

In step S604, the monitor 104 displays the image captured in the image compression unit 103. If a user of the camcorder decides to store the captured image as a still image, the user presses the storage switch 109 to the full-stroke position thereby turning on the second-stage switch SW2. In step S605, it is determined whether the switch SW2 is turned on. If it is determined in step S605 that the switch SW2 is not turned on by pressing the storage switch 109, the procedure returns to step S602.

On the other hand, if it is determined in step S605 that the switch SW2 is turned on by pressing the storage switch 109, the procedure proceeds to step S606, in which the image compression unit 103 compresses the captured image. In step S607, the compressed image file is stored into the memory card 106 via the interface unit 105.

In step S608, it is determined whether the DPOF switch 110 is pressed. If it is determined that the DPOF switch 110 is not pressed, the procedure returns to step S601 without producing a DPOF file, and displaying the playback image is continued.

On the other hand, if it is determined in step S608 that the DPOF switch 110 is pressed, the procedure proceeds to step S609 to produce DPOF data. In step S610, the DPOF data produced in the previous step is stored in the form of a file into the memory card 106 via the interface unit 105.

After completion of storing the DPOF file, the procedure returns to step S601 to continue playing back the image.

By constructing and operating the image processing apparatus in the above-described manner, it becomes possible to easily produce, in addition to a desired still image file, a DPOF file in which a print condition associated with the still image is described, simply by pressing the storage switch 109 and the DPOF switch 110 when the desired image is being displayed on the camcorder.

When no DPOF file is needed or when the user decides not to print a playback image displayed on the monitor 104 in step S604, if the DPOF switch 110 is not pressed, only the compressed image file is produced without producing an DPOF file associated with the image.

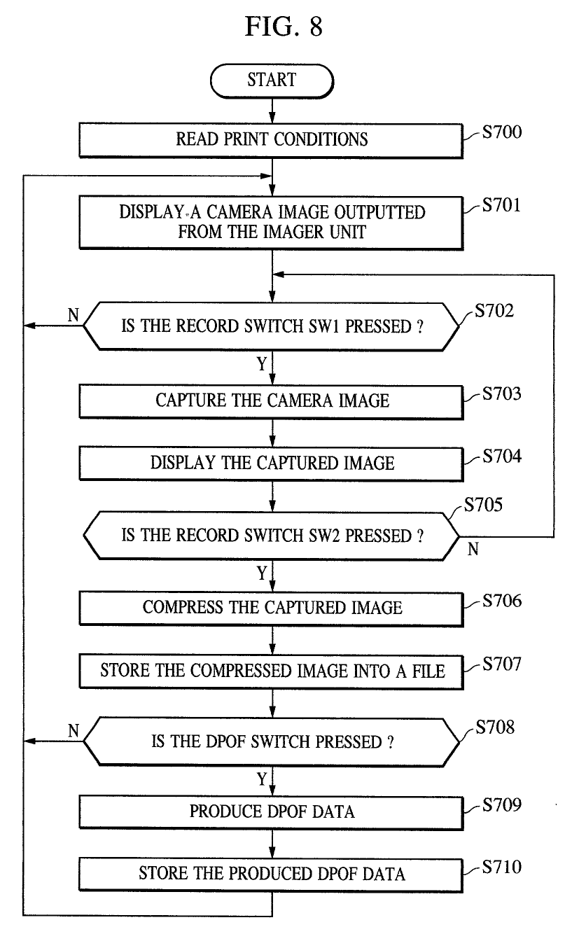

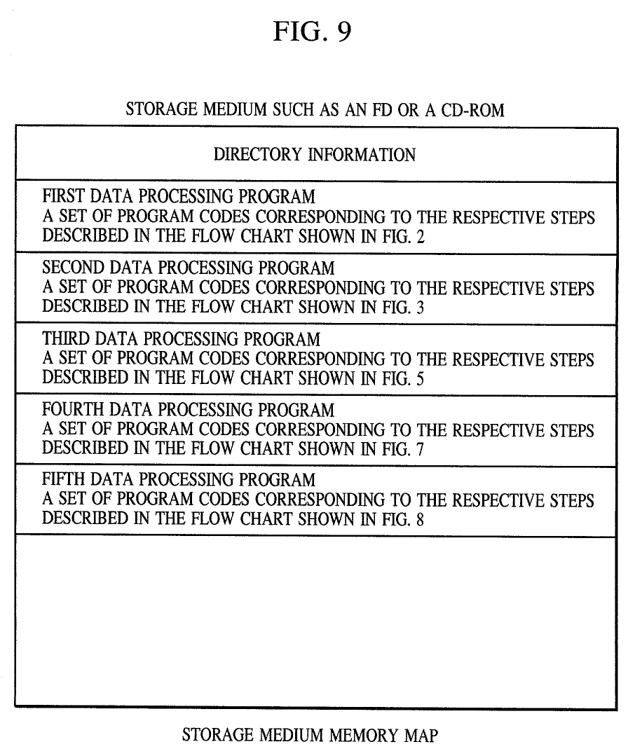

FIG. 8 is a flow chart showing an example of a fifth data processing procedure performed in the image processing apparatus according to the second embodiment. This fifth data processing procedure includes steps S700 to S710 and is concerned with an operation of the camcorder in an image taking mode, wherein the procedure is performed by the CPU 1071 in accordance with the program code stored in the program memory 1072.

First, in step S700, a preset print condition is read from the internal memory of the controller 107. In step S701, a live image being taken by the imager unit 101 is displayed on the monitor 104.

In step S702, it is determined whether the switch SW1 is turned on by pressing the storage switch 109. If it is determined in step S702 that the switch SW1 is not turned on by pressing the storage switch 109, the procedure returns to step S701 to continue displaying the live image being taken on the monitor 104.

On the other hand, if it is determined in step S702 that the switch SW1 is turned on by pressing the storage switch 109, the process proceeds to step S703, in which the image being taken by the imager unit 101 is captured into the image compression unit 103. In step S704, the monitor 104 displays the image captured in the image compression unit 103. If a user of the camcorder decides to record the captured image as a still image, the user presses the storage switch 109 to the full-stroke position thereby turning on the second-stage switch SW2.

In step S705, it is determined whether the switch SW2 is turned on by pressing the storage switch 109. If it is determined that the switch SW2 is not turned on by pressing the storage switch 109, the procedure returns to step S702.

On the other hand, if it is determined in step S705 that the switch SW2 is turned on by pressing the storage switch 109, the procedure proceeds to step S706, in which the image compression unit 103 compresses the captured image. In step S707, the compressed image file is stored into the memory card 106 via the interface unit 105. In step S708, it is determined whether the DPOF switch 110 is pressed. If it is determined that the DPOF switch 110 is not pressed, the procedure returns to step S701 without producing a DPOF file, and the live image being taken is displayed.

In the case where it is determined in step S808 that the DPOF switch 110 is pressed, the procedure proceeds to step S709, and a DPOF data is produced as described earlier. In step S710, the DPOF data produced in the previous step is stored in the form of a file into the memory card 106 via the interface unit 105. After completion of storing the DPOF file, the procedure returns to step S701 to display the live image being taken.

As described above, when the user wants to store an image being taken by the camcorder or the like, the user can easily produce, in addition to a still image file, a DPOF file in which a print condition associated with the still image is described, simply by pressing the storage switch 109 and DPOF switch 110 when the desired image is being displayed on the camcorder or the like. When no DPOF file is needed or when the user decides not to print an image displayed on the monitor 104 in step S704, if the DPOF switch 110 is not pressed, only the compressed image file is produced without producing an DPOF file associated with the image.

In the above embodiments, the manner of producing a DPOF file has been described. Note that production of a DPOF file does not limited to production of a new DPOF file.

For example, when a DPOF file already exists in a storage medium, all or a part of the existing DPOF file may be edited or modified without creating a new DPOF file. Such an operation also falls within the scope of the “production of a DPOF file”.

To deal with such a case, it is desirable to provide an additional processing unit (or step) for determine whether a DPOF file already exists in a storage medium such as a memory card.

In this case, it is also determined whether date information associated with the DPOF file is too old or whether the print condition described in the existing DPOF file is different from that stored in the controller 107.

That is, using the additional unit (step) described above, it is determined whether there is a DPOF file that has already been created.

If an existing DPOF file is detected which is too old or includes a print condition different from that stored in the controller 107, the existing DPOF file is overwritten with a new DPOF file without creating a plurality of DPOF files. This prevents an image from being printed in an unwanted manner according to an old print condition remaining without being deleted.

In the case where it is determined that the existing DPOF file has been created very recently, or it is determined that the print condition described in the existing DPOF file is the same as that stored in the controller 107, a print condition is appended to the existing DPOF file without performing overwriting. In this case, print conditions associated with a plurality of images are described in the same single DPOF file in the manner as described above with reference to FIG. 5.

Now, referring to a memory map shown in FIG. 9, a data processing program readable by an image processing system including an image processing apparatus according to the present invention is described below.

FIG. 9 illustrates a memory map of a storage medium storing various data processing programs that are readable by an image processing system including an image processing apparatus according to an embodiment of the present invention.

Although not shown in FIG. 9, information for managing the programs stored in the storage medium, such as information indicating the version, a producer, or the like, and/or other additional information, such as an icon indicating a program, depending on an operating system (OS) that reads the programs may also be stored in the storage medium.

Various data associated with the respective programs are also stored in directories shown in FIG. 9 and managed. In some cases, a program for installing a program and/or a program for decompressing a compressed program to be installed are also stored.

The respective functions of the embodiments described above with reference to FIGS. 2, 3, 5, 7, and 8 may be achieved by a host computer in accordance with a program that is provided from the outside and installed in the host computer. In this case, information including the program according to the present invention may be supplied to an output device from a storage medium such as a CD-ROM, a flash memory, or an FD, or from an external storage medium via a network.

Furthermore, the objects of the present invention may also be achieved by supplying a storage medium, on which a software program implementing the functions of any of the embodiments described above is stored, to a system or an apparatus whereby a computer (CPU or MPU) in the system or apparatus reads and executes the program code stored on the storage medium.

In this case, it should be understood that the program code read from the storage medium implements the functions of invention and thus the storage medium storing the program code falls within the scope of present invention.

Storage media which can be preferably employed in the present invention to supply the program code include a floppy disk, hard disk, optical disk, magneto-optical disk, CD-ROM, CD-R, magnetic tape, non-volatile memory card, ROM, and EEPROM.

Furthermore, the scope of the present invention includes not only such a system in which the functions of any embodiment described above is implemented simply by reading and executing a program code on a computer but also a system in which a part of or the whole of process instructed by the program code is performed using an OS (operating system) on the computer.

Furthermore, the scope of the present invention also includes a system in which a program code is transferred once from a storage medium into a memory provided in a function extension board inserted in a computer or provided in a function extension unit connected to the computer, and then a part of or the whole of process instructed by the program code is performed by a CPU or the like in the function extension board or the function extension unit thereby implementing the functions of any embodiment described above.

Items of a print condition are not limited to the print size, the number of copies to be printed, and the rotation direction.

The print condition may include other items such as color correction information, a trimming condition, a layout condition, and other processing to be performed by the image processing apparatus when an image is printed.

The present invention becomes more useful as the number of items increases, because the invention makes it possible to specify the condition in a very easy and simple fashion.

As described above, the present invention provides great advantages. That is, in an aspect of the present invention, when a command is issued to store an image being displayed, a print information file is created in accordance with a stored print condition in response to the issued command, and the created print information file is stored together with the image data being displayed into a storage medium. This makes it possible to freely configure an image processing environment that allows image data being displayed and a print information file associated with the image data to be stored in a highly efficient manner by a simple operation.

In another aspect of the present invention, if a command to create a print information file is issued in addition to a command to store image date, the print information file is created in accordance with a stored print condition in response to the command, and the created print information file is stored together with the image data being displayed into a storage medium. This makes it possible to freely configure an image processing environment that allows image data being displayed and a print information file associated with the image data to be stored in a highly efficient manner by a simple operation.

Another advantage is that when a command to store image data is issued, a print condition associated with the image data is set on the basis of a preset print condition. This makes it possible to perform both storing an image and setting a print condition at the same time.

Furthermore, because the preset print condition may be employed repeatedly, the setting of the print condition can be automatically performed without having to individually set the print condition.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structure and functions.

What is claimed is:

1. An image processing apparatus capable of storing input image data into a storage medium together with a print information file describing print information associated with the image data, the image processing apparatus comprising:
a print condition setting unit for setting a print condition;
a storage unit for storing the print condition set by the print condition setting unit;
a display unit for displaying input image data;
a storage command issuing unit for issuing a command to store the image data displayed on the display unit into the storage medium;
a producing unit for, in response to the image data storage command issued by the storage command issuing unit, producing a print information file in accordance with the print condition stored in the storage unit; and
a control unit for, in accordance with the image data storage command issued by the storage command issuing unit, controlling an operation such that the print information file produced by the producing unit and the image data displayed on the display unit are stored into the storage medium.

2. An image processing apparatus according to claim 1, further comprising a selection unit for selecting an operation mode in which a print information file is produced in accordance with the print condition stored in the storage unit,
wherein if the image data storage command is issued by the storage command issuing unit and if the selection unit selects the operation mode in which a print information file is produced, the control unit controls the operation such that the print information file produced by the producing unit and the image data displayed on the display unit are stored into the storage medium, in response to the image data storage command issued by the storage command issuing unit.

3. An image processing apparatus according to claim 1, wherein the control unit controls the operation such that the image data specified by the storage command issuing unit is stored in a compressed form into the storage medium.

4. An image processing apparatus according to claim 1, wherein the print information file is a DPOF file.

5. An image processing apparatus according to claim 1, wherein the input image data is image data captured from image data being recorded or played back.

6. An image processing apparatus according to claim 1, wherein the input image data is image data captured from image data being taken by an imaging apparatus.

7. An image processing apparatus according to claim 1, wherein the storage medium is a removable storage medium.

8. An image processing apparatus according to claim 1, wherein the removable storage medium is a detachable memory attachable/detachable to/from the image processing apparatus.

9. An image processing apparatus according to claim 1, further comprising an imager unit.

10. A method of controlling an image processing apparatus capable of storing input image data into a storage medium together with a print information file describing print information associated with the image data, the method comprising the steps of:
a set step, of setting a print condition;
a storage step, of storing the print condition set by the print condition setting step into a storage unit;
a storage command issuing step, of issuing a command to store the image data displayed on a display unit into the storage medium;
a producing step, of, in response to the image data storage command issued in the storage command issuing step, producing a print information file in accordance with the print condition stored in the storage unit; and
a control step, of, in accordance with the image data storage command issued in the storage command issuing step, controlling an operation such that the print information file produced in the producing step and the image data displayed on the display unit are stored into the storage medium.

11. A method according to claim 10, further comprising a selection step, of selecting an operation mode in which a print information file is produced in accordance with the print condition stored in the storage unit,
wherein if the image data storage command is issued in the storage command issuing step and if the mode in which a print information file is produced is selected in the selection step, the control step controls the operation such that the print information file produced in the producing step and the image data displayed on the display unit are stored into the storage medium, in response to the image data storage command issued in the storage command issuing step.

12. A method according to claim 10, wherein the control step controls the operation such that the image data specified by the storage command issuing unit is stored in a compressed form into the storage medium.

13. A method according to claim 10, wherein the print information file is a DPOF file.

14. A method according to claim 10, wherein the input image data is image data captured from image data being recorded or played back.

15. A method according to claim 10, wherein the input image data is image data captured from image data being taken by an imaging apparatus.

16. A method according to claim 10, the storage medium is a removable storage medium.

17. A method according to claim 16, the removable storage medium is a detachable memory attachable/detachable to/from the image processing apparatus.

18. A storage medium storing a program according to which a computer controls an image processing apparatus capable of storing input image data into a storage medium together with a print information file describing print information associated with the image data, the program comprising the steps of:
a set step, of setting a print condition;
a storage step, of storing the print condition set by the print condition setting step into a storage unit;
a storage command issuing step, of issuing a command to store the image data displayed on a display unit into the storage medium;
a producing step, of, in response to the image data storage command issued in the storage command issuing step, producing a print information file in accordance with the print condition stored in the storage unit; and
a control step, of, in accordance with the image data storage command issued in the storage command issuing step, controlling an operation such that the print information file produced in the producing step and the image data displayed on the display unit are stored into the storage medium.

19. A storage medium according to claim 18, further comprising a selection step, of selecting an operation mode in which a print information file is produced in accordance with the print condition stored in the storage unit,
wherein if the image data storage command is issued in the storage command issuing step and if the mode in which a print information file is produced is selected in the selection step, the control step controls the operation such that the print information file produced in the producing step and the image data displayed on the display unit are stored into the storage medium, in response to the image data storage command issued in the storage command issuing step.

20. An image processing apparatus capable of storing input image data into a storage medium together with print information file describing print information associated with the image data, the image processing apparatus comprising:
a print condition setting unit for setting a print condition;
a storage unit for storing the print condition set by the print condition setting unit;
a storage command issuing unit for issuing a command to store input image data into the storage medium;
a setting unit for, if the image data storage command is issued by the storage command issuing unit, setting the print condition stored in the storage unit to the image data; and
a control unit for, in response to the image data storage command issued by the storage command issuing unit, controlling an operation such that the image data whose print condition has been set by the setting unit is stored into the storage medium.

21. A method of controlling an image processing apparatus capable of storing input image data into a storage medium together with print information file describing print information associated with the image data, the method comprising the steps of:
a first set step, of setting a print condition;
a storage step, of storing the print condition set by the print condition setting step into a storage unit;
a storage command issuing step, of issuing a command to store input image data into the storage medium;
a second set step, of, if the image data storage command is issued in the storage command issuing step, setting the print condition stored in the storage unit to the image data; and
a control step, of, in response to the image data storage command issued in the storage command issuing step, controlling an operation such that the image data whose print condition has been set in the setting unit is stored into the storage medium.
